(19) United States
(12) Patent Application Publication
(10) Pub. No.: US 2019/0308883 A1
(43) Pub. Date: Oct. 10, 2019

(54) METHOD OF PRODUCING alpha-ALUMINA PARTICLES AND METHOD OF PRODUCING RESIN COMPOSITION

(71) Applicant: DIC Corporation, Tokyo (JP)

(72) Inventors: Jianjun Yuan, Sakura-shi (JP); Shaowei Yang, Qingdao (CN); Cheng Liu, Qingdao (CN); Shizheng Hou, Qingdao (CN)

(21) Appl. No.: 16/467,548

(22) PCT Filed: Dec. 22, 2016
(86) PCT No.: PCT/CN2016/111395

§ 371 Date: Jun. 7, 2019

(51) Int. Cl. C01F 7/30; C08K 3/22; C09K 5/14

(52) U.S. Cl. CPC C01F 7/30; C08K 3/22; C09K 5/14; C08K 2003/2227; C01P 2006/12; C01P 2004/03; C01P 2002/70; C01P 2004/61

(57) ABSTRACT

α-Alumina in the related art has an average particle diameter of 2 to 20 μm, and it can be said that the α-alumina does not necessarily a large particle diameter. As a result, with respect to the molded product obtained from a resin composition including the α-alumina in the related art as a filler, high heat dissipation characteristics are not obtained, in some cases. An object of the present invention is to provide means of producing α-alumina having a large particle diameter according to a flux method. There is provided a method of producing α-alumina particles including molybdenum which have an average particle diameter of greater than 20 μm, and the production method includes a step of firing an aluminum compound in the presence of a molybdenum compound and a potassium compound.

### TECHNICAL FIELD

The present invention relates to a method of producing α-alumina particles and a method of producing a resin composition.

### BACKGROUND ART

In the related art, reduction in size and weight and performance enhancement of instruments have been demanded, and with these, higher integration and capacity enlargement of semiconductor devices have been progressing. For this reason, the amount of heat generated in the configuration members of the instruments has increased, and thus, improvement in the heat dissipating function of the instruments is required.

Hitherto, for the members that requires high heat dissipation, mainly metallic materials and ceramic materials have been used, but metallic materials and ceramic materials have problems in lightweightness or molding processability from the viewpoint of compatibility with miniaturization of electric and electronic parts, and thus, replacement with resin materials is progressing. As a method of imparting high thermal conductivity to a resin material, for example, a method of adding an inorganic filler to the resin is known. At this time, for thermal conductivity of a molded product obtained by molding a resin composition (compound) including a resin and a filler, particularly, it is known that thermal diffusion in the thickness direction of the molded product strongly depends on the particle diameter of the filler. That is, as the particle diameter of the filler becomes larger, the interface between the filler and the resin in which heat resistance can occur in thermal diffusion in the thickness direction is reduced, and due to this, the heat dissipation characteristics of the molded product are improved. In other words, by a resin composition including a filler having a large particle diameter, a molded product having high heat dissipation characteristics can be provided.

As a thermal conductive filler, alumina (aluminum oxide), boron nitride, aluminum nitride, magnesium oxide, and magnesium carbonate may be exemplified. Since alumina is inexpensive and has excellent resin-filling properties and excellent chemical stability, alumina is widely used as a thermal conductive filler. While alumina may have various crystal forms such as α, β, γ, δ, and θ, it is known that the thermal conductivity of aluminum oxide of the α crystal form is the highest. In general, the α crystal form of alumina (α-alumina) is produced by grinding of electromolten alumina or a Bayer process, which includes firing of alumina hydroxide at high temperature. However, in these production methods, it is difficult to control the particle shape, and particularly, it is difficult to produce α-alumina having a large particle diameter and a particle shape adjusted, which can be applied for a resin filler.

In recent years, studies on inorganic material synthesis learned from nature and living organisms have been actively performed. Among these, a flux method is a method of precipitating crystals from a solution of an inorganic compound or a metal at a high temperature, by making use of the knowledge of how crystals (minerals) are produced in nature. Features of this flux method are that a crystal can be grown at a much lower temperature than the melting point of the target crystal, a crystal having very few crystal defects is grown, and a particle shape can be controlled.

In the related art, a technique for producing α-alumina by such a flux method has been reported. For example, PTL 1 describes an invention relating to a macrocrystal of α alumina which is a substantially hexagonal small plate single crystal, wherein the macrocrystal of α alumina has a diameter of the small plate of 2 to 20 μm, a thickness of 0.1 to 2 μm, and a ratio of diameter to thickness of 5 to 40. PTL 1 discloses that the above-described α-alumina can be produced from transition alumina or hydrated alumina and flux, and that the flux to be used herein has a melting point of equal to or lower than 800° C., contains chemically bonded fluorine, and melts transition alumina or hydrated alumina in the molten state.

### CITATION LIST

### Patent Literature

[PTL 1] JP-A-3-131517

### SUMMARY OF INVENTION

### Technical Problem

The α-alumina described in PTL 1 has an average particle diameter of 2 to 20 μm, and it cannot be said necessarily that the α-alumina has a large particle diameter. As a result, with respect to the molded product obtained from a resin composition including the α-alumina described in PTL 1 as a filler, there are some cases where high heat dissipation characteristics are not exhibited.

An object of the present invention is to provide means of producing α-alumina having a large particle diameter according to a flux method.

### Solution to Problem

The present inventors performed intensive studies in order to solve the above-described problems. As a result, the inventors found that the above problems can be solved by using a potassium compound in combination in the flux method, thereby completing the present invention.

That is, the present invention relates to a method of producing α-alumina particles including molybdenum, which have an average particle diameter of greater than 20 μm, and the method includes a step of firing an aluminum compound in the presence of a molybdenum compound and a potassium compound.

### Advantageous Effects of Invention

According to the present invention, there is provided a method of producing α-alumina particles having a large particle diameter according to a flux method.

### BRIEF DESCRIPTION OF DRAWINGS

FIG. 1 is an X-ray diffraction pattern of a powder sample obtained in Example 1.

FIG. 2 is an SEM image of α-alumina particles including molybdenum obtained in Example 1.

### DESCRIPTION OF EMBODIMENTS

Hereinafter, embodiments of the present invention will be described in detail.

<Method of Producing α-Alumina Particles Including Molybdenum>

The production method of α-alumina particles including molybdenum includes a step of firing an aluminum compound in the presence of a molybdenum compound and a potassium compound. In addition, if necessary, the production method includes a cooling step of cooling the α-alumina particles including molybdenum obtained in the above firing step and a post-treatment step of removing a flux agent.

[Firing Step]

The firing step is a step of firing an aluminum compound in the presence of a molybdenum compound and a potassium compound.

(Molybdenum Compound)

Although the molybdenum compound is not particularly limited, examples thereof include molybdenum compounds such as metal molybdenum, molybdenum oxide, molybdenum sulfide, lithium molybdate, sodium molybdate, potassium molybdate, calcium molybdate, ammonium molybdate, H₃PMo₁₂O₄₀, and H₃SiMo₁₂O₄₀. At this time, the above-described molybdenum compounds include isomers. For example, molybdenum oxide may be molybdenum (IV) dioxide (MoO₂), or may be molybdenum (VI) trioxide (MoO₃). In addition, potassium molybdate has a structural formula of K₂MoₙO₃ₙ₊₁, and n may be 1, may be 2, or may be 3. Among these, molybdenum trioxide, molybdenum dioxide, ammonium molybdate, or potassium molybdate is preferable, and molybdenum trioxide is more preferable.

The above-described molybdenum compounds may be used alone or in combination of two or more types thereof.

In addition, since potassium molybdate (K₂MoₙO₃ₙ₊₁, n=1 to 3) includes potassium, potassium molybdate can also have a function as a potassium compound described below.

(Potassium Compound)

Although the potassium compound is not particularly limited, examples thereof include potassium chloride, potassium chlorite, potassium chlorate, potassium sulfate, potassium hydrogen sulfate, potassium sulfite, potassium hydrogen sulfite, potassium nitrate, potassium carbonate, potassium hydrogen carbonate, potassium acetate, potassium oxide, potassium bromide, potassium bromate, potassium hydroxide, potassium silicate, potassium phosphate, potassium hydrogen phosphate, potassium sulfide, potassium hydrogen sulfide, potassium molybdate, and potassium tungstate. At this time, the potassium compound includes isomers as in the case of a molybdenum compound. Among these, potassium carbonate, potassium hydrogen carbonate, potassium oxide, potassium hydroxide, potassium chloride, potassium sulfate, or potassium molybdate is preferably used, and potassium carbonate, potassium hydrogen carbonate, potassium chloride, potassium sulfate, or potassium molybdate is more preferably used.

The above-described potassium compounds may be used alone or in combination of two or more types thereof.

In addition, since potassium molybdate includes molybdenum as described above, potassium molybdate can also have a function as the molybdenum compound described above.

The molar ratio (molybdenum element/potassium element) of the molybdenum element in the molybdenum compound to the potassium element in the potassium compound is preferably equal to or less than 5, more preferably from 0.01 to 3, still more preferably from 0.05 to 1.5, particularly preferably from 0.1 to 0.75, and most preferably from 0.15 to 0.4. If the molar ratio (molybdenum element/potassium element) is within the above range, it is preferable from the fact that α-alumina particles having a large particle diameter can be obtained.

(Aluminum Compound)

The aluminum compound is a raw material of α-alumina particles of the present invention.

The aluminum compound is not particularly limited as long as it becomes alumina particles by a heat treatment, and examples thereof include metal aluminum, aluminum sulfide, aluminum nitride, aluminum fluoride, aluminum chloride, aluminum bromide, aluminum iodide, aluminum sulfate, sodium aluminum sulfate, potassium aluminum sulfate, aluminum ammonium sulfate, aluminum nitrate, aluminum aluminate, aluminum silicate, aluminum phosphate, aluminum lactate, aluminum laurate, aluminum stearate, aluminum oxalate, aluminum acetate, basic aluminum acetate, aluminum propoxide, aluminum butoxide, aluminum hydroxide, boehmite, pseudo-boehmite, transition alumina (γ-alumina, δ-alumina, and θ-alumina), α-alumina, and mixed alumina having two or more types of crystal phase. Among these, transition alumina, boehmite, pseudo-boehmite, aluminum hydroxide, aluminum chloride, aluminum sulfate, aluminum nitrate, or hydrates thereof are preferably used, and transition alumina, boehmite, pseudo-boehmite, or aluminum hydroxide is more preferably used.

The above-described aluminum compounds may be used alone or in combination of two or more types thereof.

As the aluminum compound, commercially available products may be used, or the aluminum compound may be prepared.

In a case where an aluminum compound is prepared, for example, alumina hydrate or transition alumina having high structure stability at high temperature can be produced by neutralization of an aqueous solution of aluminum. More specifically, the alumina hydrate can be produce by neutralizing an acidic aqueous solution of aluminum with a base, and the transition alumina can be produced by heat-treating alumina hydrate obtained above. Since the alumina hydrate or the transition alumina obtained above has high structural stability at high temperature, if firing in the presence of a molybdenum compound and a potassium compound, α-alumina including molybdenum having a large average particle diameter tends to be obtained.

The shape of the aluminum compound is not particularly limited, and any one of a spherical shape, an amorphous shapes, aspect structures (wire, fiber, ribbon, a tube, and the like), a sheet shape can be suitably used.

Although the average particle diameter of the aluminum compound is not particularly limited, the average particle diameter is preferably from 5 nm to 10,000 μm.

In addition, the aluminum compound may form an organic compound and a composite. Examples of the composite include an organic-inorganic composite obtained by modifying an aluminum compound using organosilane, an aluminum compound composite on which a polymer was adsorbed, and a composite coated with an organic compound. In the case of using these composites, although the content of the organic compound is not particularly limited, the content is preferably equal to or less than 60% by mass, and more preferably equal to or less than 30% by mass.

The molar ratio (molybdenum element/aluminum element) of the molybdenum element in the molybdenum compound to the aluminum element in the aluminum compound is preferably from 0.01 to 3.0, more preferably from 0.03 to 1.0, still more preferably from 0.04 to 0.85, particularly preferably from 0.05 to 0.5, and most preferably from 0.1 to 0.25. If the molar ratio (molybdenum element/aluminum element) is within the above range, it is preferable from the fact that α-alumina particles having a large particle diameter can be obtained.

(Metal Compound)

The metal compound, as described below, can have a function of accelerating crystal growth of X-alumina. The metal compound can be used at the time of firing as desired.

Although the metal compound is not particularly limited, the metal compound preferably includes at least one selected from the group consisting of metal compounds of the Group II, metal compounds of the Group III, and metal compounds of the Group IV.

Examples of the metal compounds of the Group II include a magnesium compound, a calcium compound, a strontium compound, and a barium compound.

Examples of the metal compounds of the Group III include a scandium compound, an yttrium compound, a lanthanum compound, and a cerium compound.

Examples of the metal compounds of the Group IV include a titanium compound and a zirconium compound.

The above-described metal compounds mean oxides, hydroxides, carbonates, and chlorides of metal elements. As an yttrium compound, yttrium oxide (Y₂O₃), yttrium hydroxide, and carbonated yttrium can be exemplified. Among these, the metal compound is preferably an oxide of a metal element. These metal compounds include isomers.

Among these, metallic compounds of the 3rd period elements, metal compounds of the 4th period elements, metal compounds of the 5th period elements, or metal compounds of the 6th period elements are preferable, metal compounds of the 4th period elements or metal compounds of the 5th period elements are more preferable, and metal compounds of the 5th period elements are still more preferable. Specifically, a magnesium compound, a calcium compound, an yttrium compound, a lanthanum compound, or a zirconium compound is preferably used, a magnesium compound, a calcium compound, an yttrium compound, or a zirconium compound is more preferably used, an yttrium compound or a zirconium compound is still more preferably used, and a zirconium compound is particularly preferably used.

The addition ratio of a metal compound is preferably from 0.02% to 20% by weight, more preferably from 0.6% to 20% by weight, and still more preferably from 5% to 15% by weight, with respect to the mass conversion value of the aluminum atoms in the aluminum compound. If the addition ratio of a metal compound is equal to or greater than 0.02% by weight, crystal growth of α-alumina including molybdenum can suitably proceed, and thus, this is preferable. On the other hand, if the addition ratio of a metal compound is equal to or less than 20% by weight, it is possible to obtain α-alumina having a low content of impurities derived from a metal compound, and thus, this is preferable.

(Firing)

By firing an aluminum compound in the presence of a molybdenum compound and a potassium compound, it is possible to obtain α-alumina particles including molybdenum. The production method is based on a flux method.

The flux method is classified as a solution method. More specifically, the flux method is a crystal growth method using the fact that a crystal-flux 2-component system phase diagram shows a eutectic type. The mechanism of the flux method is assumed to be as follows. That is, if a mixture of a solute and flux is heated, the solute and the flux become liquid phases. At this time, since the flux is a fusing agent, in other words, since the solute-flux 2-component system phase diagram shows a eutectic type, the solute melts at a temperature lower than the melting point thereof and configures a liquid phase. If the flux is evaporated in this state, the concentration of the flux is lowered, in other words, melting point lowering effects of the solute by the flux are reduced, evaporation of the flux becomes a driving force, and thus, crystal growth of the solute occurs (flux evaporation method). The solute and the flux can cause crystal growth of the solute also by cooling the liquid phase (slow cooling method).

The flux method has merits that it is possible to grow a crystal at a much lower temperature than the melting point, it is possible to precisely control the crystal structure, and it is possible to form a polyhedron crystal having euhedral.

In production of α-alumina particles by the flux method using a molybdenum compound as flux, the mechanism thereof is not entirely clear, but for example, is assumed to be due to the following mechanism. That is, if firing an aluminum compound in the presence of a molybdenum compound, first, aluminum molybdate is formed. At this time, as will be understood from the above description, the aluminum molybdate grows an α-alumina crystal at a temperature lower than the melting point of alumina. For example, by evaporating the flux, aluminum molybdate is decomposed, and a crystal grows, and as a result, α-alumina particles can be obtained. That is, a molybdenum compound functions as flux, and through an intermediate of aluminum molybdate, α-alumina particles are produced.

Here, if using a potassium compound in combination in the flux method, α-alumina particles having a large particle diameter can be produced. More specifically, if using a molybdenum compound and a potassium compound in combination, first, the molybdenum compound and the potassium compound are reacted, and as a result, potassium molybdate is formed. At the same time, the molybdenum compound is reacted with the aluminum compound, and as a result, aluminum molybdate is formed. For example, aluminum molybdate is decomposed in the presence of potassium molybdate, and a crystal grows, and as a result, α-alumina particles having a large particle diameter can be obtained. That is, when α-alumina particles are produced through an intermediate of aluminum molybdate, if potassium molybdate is present, α-alumina particles having a large particle diameter are obtained.

That is, although the reason for this is not clear, α-alumina particles having a large particle diameter can be obtained in the case of obtaining α-alumina particles in the presence of potassium molybdate based on aluminum molybdate compared with the case of obtaining α-alumina particles based on aluminum molybdate. The above mechanism is only a presumption, and even a case where the effects of the present invention are obtained by a mechanism different from the above mechanism is included in the technical scope of the present invention. In addition, in the present specification, “large particle diameter” means particles having an average particle diameter of greater than 20 μm. At this time, the “particle diameter” means the maximum length among the distances between two points on the contour line of particles, and the value of the “average particle diameter” means a value measured and calculated by the method described in examples.

Although the structure of the potassium molybdate described above is not particularly limited, typically, the structure includes a molybdenum atom, a potassium atom, and an oxygen atom. The structural formula is preferably represented by K₂MoₙO₃ₙ₊₁. At this time, although n is not particularly limited, if n is within a range of 1 to 3, α-alumina particle growth acceleration is effectively functioned, and thus, this is preferable. Other atoms may be included in the potassium molybdate, and examples of other atoms include sodium, magnesium, silicon, and iron.

There is a tendency that the average particle diameter of α-alumina particles can be controlled, for example, by suitably changing the molar ratio (molybdenum/aluminum) of the molybdenum atoms in the molybdenum compound to the aluminum atoms in the aluminum compound, the molar ratio (molybdenum/potassium) of the molybdenum atoms in the molybdenum compound to the potassium atoms in the potassium compound, the firing temperature, or the shape of the aluminum compound.

In one embodiment of the present invention, the above-described firing may be performed in the presence of a metal compound. That is, in the firing, the metal compound described above can be used in combination with a molybdenum compound and a potassium compound. Thus, α-alumina particles having a larger particle diameter can be produced. The mechanism thereof is not entirely clear, but for example, is assumed to be due to the following mechanism. That is, it is thought that, by a metal compound being present at the time of crystal growth of α-alumina particles, prevention or suppression of formation of α-alumina crystal nuclei and/or diffusion acceleration of an aluminum compound required for crystal growth of α-alumina, in other words, prevention of excessive generation of an α-crystal nucleus and/or a function of increase in the diffusion rate of an aluminum compound is exhibited, and α-alumina particles having a large particle diameter are obtained. The above mechanism is only a presumption, and even a case where the effects of the present invention are obtained by a mechanism different from the above mechanism is included in the technical scope of the present invention.

Although the firing temperature is not particularly limited, the firing temperature is preferably 700° C. or higher, more preferably 900° C. or higher, still more preferably from 900° C. to 2,000° C., particularly preferably from 900° C. to 1,000° C., and most preferably from 900° C. to 960° C. If the firing temperature is equal to or higher than 700° C., a flux reaction suitably proceeds, and thus, this is preferable.

Although the state of the molybdenum compound, the potassium compound, or the aluminum compound at the time of firing is not particularly limited, these may be mixed. As the mixing method, simple mixing for mixing powders, mechanical mixing using a pulverizer or a mixer, and mixing using a mortar can be exemplified. At this time, the obtained mixture may be any one of a dry state and a wet state, and a dry state is preferable from the viewpoint of cost.

Although the firing time is not particularly limited, the firing time is preferably from 0.1 to 1,000 hours, and more preferably from 1 to 100 hours from the viewpoint of efficiently performing formation of α-alumina particles. If the firing time is equal to or greater than 0.1 hours, α-alumina particles having a large average particle diameter can be obtained, and thus, this is preferable. On the other hand, if the firing time is within 1,000 hours, the production cost can be reduced, and thus, this is preferable.

Although the atmosphere of firing is not particularly limited, for example, an oxygen-containing atmosphere such as an air atmosphere or an oxygen atmosphere or an inert atmosphere such as a nitrogen atmosphere or an argon atmosphere is preferable, an oxygen-containing atmosphere or a nitrogen atmosphere, not having corrosivity is more preferable from the viewpoint of the safety of a practitioner or the durability of a furnace, and an air atmosphere is still more preferable from the viewpoint of cost.

The pressure at the time of firing is not particularly limited, and the firing may be performed under normal pressure, under pressurization, or under reduced pressure. Although the heating means is not particularly limited, a firing furnace is preferably used. As a firing furnace which can be used at this time, a tunnel furnace, a roller hearth furnace, a rotary kiln, and a muffle furnace can be exemplified.

[Cooling Step]

The production method of the present invention may include a cooling step. The cooling step is a step of cooling α-alumina crystal-grown in the firing step.

Although the cooling speed is not particularly limited, the cooling speed is preferably from 1 to 1,000° C./h, more preferably from 5 to 500° C./h, and still more preferably from 50 to 100° C./h. If the cooling speed is equal to or greater than 1° C./h, the production time can be shortened, and thus, this is preferable. On the other hand, if the cooling speed is equal to or less than 1,000° C./h, the firing container is less likely to be cracked by heat shock and can be used longer, and thus, this is preferable.

The cooling method is not particularly limited, and may be natural cooling, or a cooling apparatus may be used.

[Post-Treatment Step]

The production method of the present invention may include a post-treatment step. The post-treatment step is a step of removing a flux agent. The post-treatment step may be performed after the firing step described above, may be performed after the cooling step described above, or may be performed after the firing step and the cooling step. In addition, if necessary, the post-treatment step may be repeatedly performed two or more times.

As the method of post-treatment, washing and a high temperature treatment can be exemplified. These can be performed in combination.

Although the described-above washing method is not particularly limited, in a case where the flux is water-soluble, washing with water can be exemplified.

In addition, as the high temperature treatment method, a method of raising the temperature to equal to or higher than the sublimation point or the boiling point of the flux can be exemplified.

<α-Alumina Particles Including Molybdenum>

The α-alumina particles obtained by the production method of the present invention includes molybdenum.

Although the containing form of molybdenum is not particularly limited, a form in which molybdenum is disposed in a form of attachment, coating, and bonding to α-alumina particle surface, and in other forms similar thereto, a form in which molybdenum is incorporated into α-alumina particles, and a combined form thereof are exemplified. At this time, as “a form in which molybdenum is incorporated into α-alumina particles”, a form in which at least a portion of the atoms configuring the α-alumina particles is substituted with molybdenum and a form in which molybdenum is disposed in the space (including the space or the like caused by defects in the crystal structure) which can be present inside the crystal of α-alumina particles are exemplified. In the form of substituting, the atom configuring the α-alumina particles to be substituted is not particularly limited, and the atom may be any one of an aluminum atom, an oxygen atom, and other atoms.

Since α-alumina particles include molybdenum, typically, α-alumina particles are colored. The colored color varies depending on the amount of molybdenum contained, but typically, the color is from a light blue color to a dark blue color close to a black color, and the color tends to become a dark color in proportion to the molybdenum content. Depending on the configuration of α-alumina particles including molybdenum according to the present embodiment, the α-alumina particles are colored into other colors in some cases. For example, in a case where the compound including molybdenum includes chromium, the α-alumina particles can be colored into a red color, and in a case where the compound including molybdenum includes nickel, the α-alumina particles can be colored into a yellow color.

The average particle diameter of α-alumina particles is greater than 20 μm, preferably greater than 20 μm and equal to or less than 1,000 μm, more preferably greater than 20 μm and equal to or less than 500 μm, and still more preferably greater than 20 μm and equal to or less than 200 μm. If the average particle diameter of α-alumina particles is equal to or greater than 20 μm, it is possible to realize high thermal conduction rate of the compound produced by using as a resin filler, and thus, this is preferable. If the average particle diameter of α-alumina particles is equal to or less than 1,000 μm, for example, in a thermoplastic resin composition, the surface of the molded product thereof is less likely to roughen, and a good molded product can be easily obtained. In addition, for example, in the case of a thermosetting resin composition, in a case where a substrate and a substrate are adhered, the adhesion of the interface between the cured product and the substrate is not decreased, and crack resistance in a hot-cold cycle or peeling properties at the adhesion interface is excellent, and thus, this is preferable.

The shape of α-alumina particles is not particularly limited, and examples thereof include a polyhedron shape, a plate shape, a needle shape, a rod shape, a disk shape, a flake shape, a scale shape, a spherical shape, an elliptical shape, and a cylindrical shape. Among these, from the viewpoint of easy dispersion to the resin, a polyhedron shape, a spherical shape, an elliptical shape, or a plate shape is preferable, and a polyhedron shape is more preferable. If the shape of α-alumina particles is a polyhedron shape, when the particles in the resin composition come into contact with each other, it is possible that there exists planar contact between the particles which is beneficial for heat dissipation, resulting in that high thermal conductivity can be obtained for resin composition even in the case of the same filling degree compared with spherical particles, and thus, this is preferable. At this time, α-alumina particles are preferably shapes other than a hexagonal bipyramidal type in a polyhedron shape, and are more preferably octa- or higher polyhedrons. If α-alumina particles are shapes other than a hexagonal bipyramidal type, there is no or almost no acute angle, and due to this, when producing a resin composition, it is possible to prevent or suppress problems such as damage of the instrument, and thus, this is preferable.

The major crystal plane of α-alumina particles preferably has crystal planes other than the plane [001] as the major crystal plane. The major crystal plane of α-alumina particles can typically be controlled by suitably changing the conditions of the firing step. In addition, in the present specification, “crystal planes other than the plane [001] as the major crystal plane” means that the area of the plane [001] is 20% or less with respect to the entire area of the particles.

The α crystallization degree of α-alumina particles is preferably 90% or more, and more preferably from 95% to 100%. If the α crystallization degree is equal to or greater than 90%, it is advantageous for high thermal conductivity of α-alumina particles, and thus, this is preferable.

Although the specific surface area of α-alumina particles is not particularly limited, the specific surface area is preferably from 0.0001 to 50 m²/g, more preferably from 0.0001 to 10 m²/g, and still more preferably from 0.001 to 5 m²/g. If the specific surface area of α-alumina particles is 0.0001 m²/g or more, the average particle diameter of the α-alumina becomes equal to or less than 1 mm, in the case of molding a composition obtained by mixing with a resin, the surface of the molded product can become smooth, and mechanical properties of the molded product are excellent, and thus, this is preferable from these viewpoints. On the other hand, if the specific surface area of the aluminum compound is 50 m²/g or less, the viscosity of the composition obtained by mixing with the resin does not become excessively large, and thus, this is preferable. In the present specification, the “specific surface area” means a BET specific surface area, and as the value thereof, a value measured by the method described in examples is employed.

(Molybdenum)

Molybdenum can be contained by the production method described above.

The molybdenum can be contained in a form disposed in a form of attachment, coating, and bonding to α-alumina particle surface, and in other forms similar thereto, in a form in which molybdenum is incorporated into the alumina structure, or by combination thereof.

In the molybdenum, a molybdenum atom and molybdenum in the molybdenum compound described above are included.

Although the molybdenum content is not particularly limited, from the viewpoint of the high thermal conductivity of α-alumina particles, the content is preferably from 0.001% to 10% by mass, more preferably from 0.01% to 5% by mass, and from the viewpoint that α-alumina particles exhibit high compactness, still more preferably from 0.05% to 2% by mass, in terms of molybdenum oxide with respect to the α-alumina particles. If the molybdenum content is 0.001% by mass or more, crystal growth of α-alumina particles can more efficiently proceed, and the crystal quality can be improved, and thus, this is preferable. On the other hand, if the molybdenum content is 10% by mass or less, α-alumina particles having small defects and fluctuation of crystal are obtained, and the thermal conductivity of particles can be improved, and thus, this is preferable. In the present specification, as the value of “molybdenum content”, a value measured by the method described in examples is employed.

(Inevitable Impurities)

α-Alumina particles can include inevitable impurities.

The inevitable impurities are derived from the potassium compound and the metal compound used in production, present in the raw materials, or inevitably mixed in α-alumina particles in the production step, and although the inevitable impurities are essentially unnecessary, the inevitable impurities mean impurities which are a trace amount, and do not affect the characteristics of α-alumina particles.

Although the inevitable impurities are not particularly limited, examples thereof include potassium, magnesium, calcium, strontium, barium, scandium, yttrium, lanthanum, titanium, zirconium, cerium, silicon, iron, and sodium. These inevitable impurities may be included alone, or two or more types thereof may be included.

The content of the inevitable impurities in α-alumina particles is preferably 10,000 ppm or less, more preferably 1,000 ppm or less, and still more preferably from 10 to 500 ppm, with respect to the mass of the α-alumina particles.

(Other Atoms)

Other atoms mean atoms intentionally added to α-alumina particles for the purpose of imparting functions such as coloring and light emission within a range not impairing the effects of the present invention.

Although other atoms are not particularly limited, examples thereof include zinc, cobalt, nickel, iron, manganese, titanium, zirconium, calcium, strontium, and yttrium. These other atoms may be used alone or in a mixture of two or more types thereof.

The content of other atoms in α-alumina particles is preferably 10% by mass or less, more preferably 5% by mass or less, and still more preferably 2% by mass or less, with respect to the mass of the α-alumina particles.

<Method of Producing Resin Composition>

According to an embodiment of the present invention, there is provided a method of producing a resin composition.

The production method includes a step of mixing the α-alumina particles produced by the above-described method and a resin.

[α-Alumina Particles]

Since the above-described alumina particles can be used as the α-alumina particles, the description thereof is not repeated.

As the α-alumina particles, surface-treated alumina particles can be used.

In addition, the α-alumina particles to be used may be used alone or in combination of two or more types thereof.

Furthermore, α-alumina particles and other fillers (alumina, spinel, boron nitride, aluminum nitride, magnesium oxide, and magnesium carbonate) may be used in combination.

The content of the α-alumina particles is preferably from 5% to 95% by mass, and more preferably from 10% to 90% by mass, with respect to the mass of the resin composition. If the content of the α-alumina particles is 5% by mass or more, it is possible to efficiently exhibit high thermal conductivity of the α-alumina particles, and thus, this is preferable. On the other hand, if the content of the α-alumina particles is 95% by mass or less, it is possible to obtain a resin composition having excellent moldability, and thus, this is preferable.

[Resin]

The resin is not particularly limited, and examples thereof include a thermoplastic resin and a thermosetting resin.

The thermoplastic resin is not particularly limited, and resins known in the related art used for molding materials or the like can be used. Specific examples thereof include a polyethylene resin, a polypropylene resin, a polymethyl methacrylate resin, a polyvinyl acetate resin, an ethylene-propylene copolymer, an ethylene-vinyl acetate copolymer, a polyvinyl chloride resin, a polystyrene resin, a polyacrylonitrile resin, a polyamide resin, a polycarbonate resin, a polyacetal resin, a polyethylene terephthalate resin, a polyphenyleneoxide resin, a polyphenylene sulfide resin, a polysulfone resin, a polyether sulfone resin, a polyether ether ketone resin, a polyallyl sulfone resin, a thermoplastic polyimide resin, a thermoplastic urethane resin, a polyaminobismaleimide resin, a polyamide-imide resin, a polyetherimide resin, a bismaleimidetriazine resin, a polymethylpentene resin, fluoride resin, a liquid crystal polymer, an olefin-vinyl alcohol copolymer, an ionomer resin, a polyarylate resin, an acrylonitrile-ethylene-styrene copolymer, an acrylonitrile-butadiene-styrene copolymer, and an acrylonitrile-styrene copolymer.

The above-described thermosetting resin is a resin having a characteristic that the resin can substantially change into being insoluble and infusible when cured by means of heating, radiation, or a catalyst, and in general, resins known in the related art used for molding materials or the like can be used. Specifically, examples thereof include novolac type phenolic resins such as a phenol novolac resin and a cresol novolac resin; phenolic resins such as resol type phenolic resins including an unmodified resol phenolic resin and an oil-modified resol phenolic resin modified with tung oil, linseed oil, or walnut oil; bisphenol type epoxy resins such as a bisphenol A epoxy resin and a bisphenol F epoxy resin; novolac type epoxy resins such as a fatty chain-modified bisphenol type epoxy resin, a novolac epoxy resin, and a cresol novolac epoxy resin; epoxy resins such as a biphenyl type epoxy resin and a polyalkylene glycol type epoxy resin; resins having a triazine ring such as a urea resin and a melamine resin; vinyl resins such as a (meth)acrylic resin and a vinyl ester resin: and unsaturated polyester resins, bismaleimide resins, polyurethane resins, diallyl phthalate resins, silicone resins, resins having a benzoxazine ring, and cyanate ester resins.

The above-described resins may be used alone or in combination of two or more types thereof. At this time, two or more types of thermoplastic resin may be used, two or more types of thermosetting resin may be used, or one or more types of thermoplastic resin and one or more types of thermosetting resin may be used in combination.

The content of the resin is preferably from 5% to 90% by mass, and more preferably from 10% to 70% by mass, with respect to the mass of the composition. If the content of the resin is 5% by mass or more, excellent moldability can be imparted to the resin composition, and thus, this is preferable. On the other hand, if the content of the resin is 90% by mass or less, it is possible to obtain high thermal conductivity as a compound by molding, and thus, this is preferable.

[Curing Agent]

A curing agent may be mixed in the resin composition as necessary.

The curing agent is not particularly limited, and known curing agents can be used.

Specifically, examples thereof include an amine-based compound, an amide-based compound, an acid anhydride-based compound, and a phenol-based compound.

Examples of the amine-based compound include diaminodiphenylmethane, diethylenetriamine, triethylenetetramine, diaminodiphenylsulfone, isophoronediamine, imidazole, BF₃-amine complexes, and guanidine derivatives.

Examples of the amide-based compound include dicyandiamide and a polyamide resin synthesized from a dimer of linolenic acid and ethylenediamine.

Examples of the acid anhydride-based compound include phthalic anhydride, trimellitic anhydride, pyromellitic anhydride, maleic anhydride, tetrahydrophthalic anhydride, methyltetrahydrophthalic anhydride, methylnadic anhydride, hexahydrophthalic anhydride, and methylhexahydrophthalic anhydride.

Examples of the phenol-based compound include a phenol novolac resin, a cresol novolac resin, an aromatic hydrocarbon formaldehyde resin-modified phenolic resin, a dicyclopentadiene phenol adduct type resin, a phenol aralkyl resin (xylok resin), a polyphenol novolac resin synthesized from a polyhydroxy compound represented by a resorcinol novolac resin and formaldehyde, a naphthol aralkyl resin, a trimethylol methane resin, a tetraphenylol ethane resin, a naphthol novolac resin, a naphthol-phenol co-condensed novolac resin, a naphthol-cresol co-condensed novolac resin, polyphenol compounds such as a biphenyl-modified phenolic resin (polyphenol compound in which a phenolic nucleus is linked by a bismethylene group), a biphenyl-modified naphthol resin (polynaphthol compound in which a phenolic nucleus is linked by a bismethylene group), an aminotriazine-modified phenolic resin (polyphenol compound in which a phenolic nucleus is linked by melamine, benzoguanamine, or the like), and an alkoxy group-containing aromatic ring-modified novolac resin (polyphenol compound in which a phenolic nucleus and an alkoxy group-containing aromatic ring are linked by formaldehyde).

The above-described curing agents may be used alone or in combination of two or more types thereof.

[Curing Accelerator]

A curing accelerator may be mixed in the resin composition as necessary.

The curing accelerator has a function of accelerating curing at the time of curing a composition.

Although the curing accelerator is not particularly limited, examples thereof include phosphorus-based compounds, tertiary amines, imidazoles, organic acid metal salts, Lewis acids, and amine complex salts.

The above-described curing accelerators may be used alone or in combination of two or more types thereof.

[Curing Catalyst]

A curing catalyst may be mixed in the resin composition as necessary.

Instead of the curing agent, the curing catalyst has a function of proceeding the curing reaction of a compound having an epoxy group.

The curing catalyst is not particularly limited, and thermal polymerization initiators or active energy ray polymerization initiators known in the related art can be used.

The curing catalyst may be used alone or in combination of two or more types thereof.

[Viscosity Modifier]

A viscosity modifier may be mixed in the resin composition as necessary.

The viscosity modifier has a function of adjusting the viscosity of the composition.

The viscosity modifier is not particularly limited, and an organic polymer, polymer particles, or inorganic particles can be used.

The viscosity modifier may be used alone or in combination of two or more types thereof.

[Plasticizer]

A plasticizer may be mixed in the resin composition as necessary.

The plasticizer has a function of improving processability, flexibility, and weather resistance of thermoplastic synthetic resins.

The plasticizer is not particularly limited, and phthalic acid ester, adipic acid ester, phosphoric acid ester, trimellitic acid ester, polyester, polyolefin, or polysiloxane can be used.

The above-described plasticizers may be used alone or in combination of two or more types thereof.

[Mixing]

The resin composition according to the present embodiment can be obtained by mixing α-alumina particles and a resin, and by mixing other blended product as necessary. The mixing method is not particularly limited, and mixing is performed by a method known in the related art.

In a case where the resin is a thermosetting resin, as the mixing method of a general thermosetting resin, α-alumina particles, and the like, a method in which a predetermined blending amount of thermosetting resin, α-alumina particles, and as necessary, other components are sufficiently mixed using a mixer or the like, kneaded using a three-roll or the like, and as a result, a liquid composition having fluidity is obtained is exemplified. In addition, as the mixing method of a thermosetting resin, α-alumina particles, and the like in another embodiment, a method in which a predetermined blending amount of thermosetting resin, α-alumina particles, and as necessary, other components are sufficiently mixed using a mixer or the like, melt-kneaded using a mixing roll, an extruder, or the like, cooled, and as a result, a solid composition is obtained is exemplified. Regarding the mixed state, in a case where a curing agent, a catalyst, or the like is blended, the curable resin and the blended product thereof may be sufficiently uniformly mixed, and it is more preferable that α-alumina particles are also uniformly dispersed and mixed.

As the mixing method of a general thermoplastic resin, α-alumina particles, and the like in a case where the resin is a thermoplastic resin, a method in which a thermoplastic resin, α-alumina particles, and as necessary, other components are mixed in advance using various mixers such as a tumbler, and a Henschel mixer, and melt-kneaded using a mixer such as a Banbury mixer, a roll, a Brabender, a single-screw extruder, a twin-screw extruder, a kneader, or a mixing roll is exemplified. Although the temperature of melt-kneading is not particularly limited, the temperature is typically within a range of 240° C. to 320° C.

To more enhance the fluidity of the resin composition or filler-filling properties of α-alumina particles, a coupling agent may be externally added to the resin composition. By externally adding a coupling agent, the adhesion between the resin and the α-alumina particles can be further enhanced, the interface thermal resistance between the resin and the α-alumina particles can be reduced, and the thermal conductivity of the resin composition can be improved.

Although the coupling agent is not particularly limited, a silane-based coupling agent is preferably used. Although the silane coupling agent is not particularly limited, examples thereof include vinyl trichlorosilane, vinyl triethoxysilane, vinyl trimethoxysilane, γ-methacryloxypropyl trimethoxysilane, β(3,4 epoxycyclo hexyl)ethyl trimethoxysilane, γ-glycidoxypropyl trimethoxysilane, γ-glycidoxypropyl methyldiethoxysilane, N-β(aminoethyl) γ-aminopropyl trimethoxysilane, N-β(aminoethyl) γ-aminopropylmethyl dimethoxysilane, γ-aminopropyl triethoxysilane, N-phenyl-γ-aminopropyl trimethoxysilane, γ-mercaptopropyl trimethoxysilane, and γ-chloropropyl trimethoxysilane.

The above-described coupling agents may be used alone or in combination of two or more types thereof.

Although the addition amount of the coupling agent is not particularly limited, the addition amount is preferably from 0.01% to 5% by mass, and more preferably from 0.1% to 3% by mass, with respect to the mass of the resin.

[Resin Composition]

According to an embodiment, the resin composition is used for thermal conductive materials.

Since the α-alumina particles contained in the resin composition has a particle diameter of greater than 20 μm, and the thermal conductivity of the resin composition is excellent, the resin composition is preferably used as an insulating heat dissipating member. Thus, it is possible to improve the heat dissipating function of equipment, and it is possible to contribute to reduction in size and weight and performance enhancement of equipment.

<Method of Producing Cured Product>

According to an embodiment of the present invention, there is provided a method of producing a cured product. The production method includes curing the resin composition produced above.

Although the curing temperature is not particularly limited, the curing temperature is preferably from 20° C. to 300° C., and more preferably from 50° C. to 200° C.

Although the curing time is not particularly limited, the curing time is preferably from 0.1 to 10 hours, and more preferably from 0.2 to 3 hours.

The shape of the cured product varies depending on the desired application, and is suitably designed by those skilled in the art.

### EXAMPLES

Hereinafter, the present invention will be specifically described with reference to examples, but the present invention is not limited thereto.

### Example 1

(Production of α-Alumina Particles Including Molybdenum)

50 g of aluminum oxide (CHNALCO, manufactured by Shandong Co. Ltd., transition alumina, average particle diameter of 45 μm), 66.75 g of molybdenum trioxide (manufactured by Aladdin Industrial Corporation), 33.75 g of potassium carbonate (manufactured by Aladdin Industrial Corporation), and 0.25 g of yttrium oxide (manufactured by Aladdin Industrial Corporation) were mixed in a mortar. The obtained mixture was put into a crucible, and firing was performed at 950° C. for 10 hours in a ceramic electric furnace ARF-100K type firing furnace (ceramic electric furnace, manufactured by Asahi-Rika Co., Ltd.) provided with an AMF-2P type temperature controller. After cooling to room temperature, the crucible was taken out, the contents were washed with ion exchange water. Finally, drying was performed at 150° C. for 2 hours, whereby α-alumina powder including molybdenum having a blue color was obtained.

The molar ratio (molybdenum element/aluminum element) of the molybdenum element in the molybdenum compound to the aluminum element in the aluminum compound was 0.36. In addition, the molar ratio (molybdenum element/potassium element) of the molybdenum element in the molybdenum compound to the potassium element in the potassium compound was 0.95. Furthermore, the addition ratio of a metal compound to the mass conversion value of the aluminum atoms in the aluminum compound was 0.95% by mass.

(Evaluation)

The following evaluations were performed on the powder sample and the produced α-alumina particles including molybdenum.

<Analysis of Crystal Structure>

The crystal structure of the powder sample was analyzed by an X-ray diffraction method (XRD).

Specifically, analysis was performed using Rint-TT II (manufactured by Rigaku Corporation) which is a wide angle X-ray diffractometer. At this time, as the measurement method, a 2θ/θ method was used. In addition, as the measurement conditions, the scan speed was 2.0 degrees/min, the scan range was 5 to 70 degrees, and the step was 0.02 degrees.

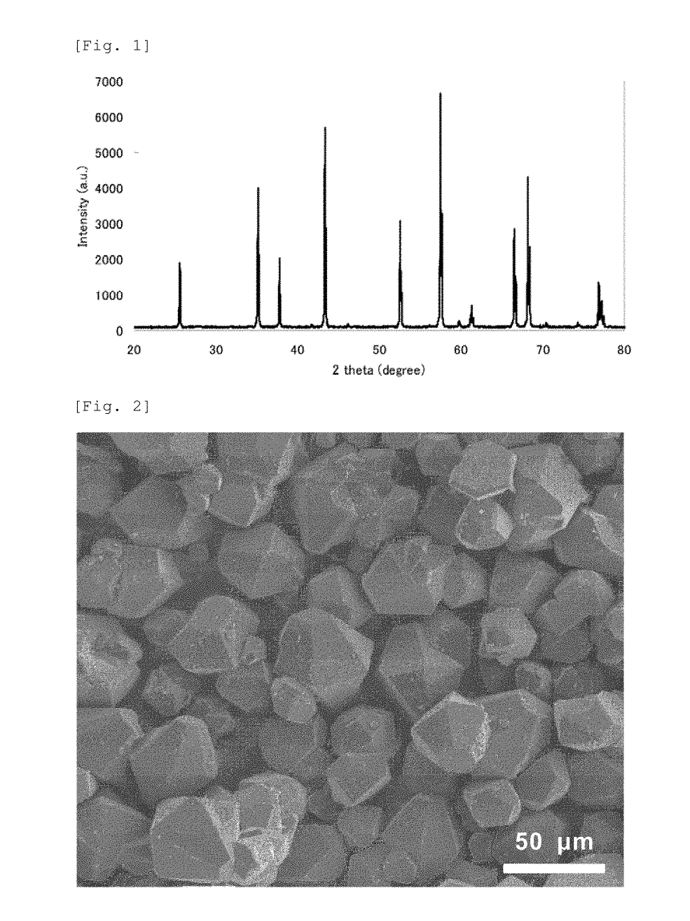

As a result, the powder sample showed a sharp scattering peak derived from the α-alumina, and any peak of an alumina crystal system other than the α crystal structure was not observed. FIG. 1 shows the measured X-ray diffraction pattern.

<Observation of Polyhedron Shape and Measurement of Average Particle Diameter>

Observation of the polyhedron shape and measurement of the average particle diameter were performed on the produced α-alumina particles including molybdenum using a scanning electron microscope (SEM).

Specifically, observation of the polyhedron shape and measurement of the average particle diameter were performed using VE-9800 (manufactured by Keyence Corporation) which is a surface observation apparatus.

More specifically, for the polyhedron shape, observation was performed on images obtained from a plurality of SEM images from arbitrary viewing fields of the sample. The shape of equal to or greater than 60% of the particles was determined to be polyhedron shape of the sample.

In addition, the value of the average particle diameter means a value measured and calculated from arbitrary 100 of α-alumina particles including molybdenum in images obtained from a plurality of SEM images from arbitrary viewing fields of the sample.

As a result, it was confirmed that the α-alumina particles had a crystal plane other than the plane [001] as the major crystal plane, and were polyhedron particles having a crystal plane having a larger area than the plane [001]. The α-alumina particles were octa- or higher polyhedron particles, other than hexagonal bipyramidal forms.

In addition, the average particle diameter was 50 μm.

FIG. 2 shows an SEM image of the obtained α-alumina particles including molybdenum.

<Measurement of Molybdenum Content>

Measurement of the molybdenum content was performed on the produced α-alumina particles including molybdenum by fluorescent X-ray measurement (XRF).

Specifically, the measurement of the molybdenum content was performed using ZSX100e (manufactured by Rigaku Corporation) which is a fluorescent X-ray analysis apparatus. At this time, as the measurement method, an FP (function point) method was used. In addition, as the measurement conditions, EZ scan was used, the measurement range was B to U, the measurement diameter was 10 mm, and the sample weight was 50 mg. The measurement was performed in the powder form, and at this time, a polypropylene (PP) film was used to prevent scattering.

As a result, the molybdenum content of the α-alumina particles including molybdenum was 0.2% as a value in terms of molybdenum oxide.

<Measurement of Specific Surface Area>

Measurement of the BET specific surface area was performed on the produced α-alumina particles including molybdenum.

Specifically, the measurement of the BET specific surface area was performed using a TriStar 3000 type apparatus (manufactured by Micromeritics Instrument Corporation). At this time, as the measurement method, a nitrogen gas adsorption/desorption method was used.

As a result, the specific surface area of α-alumina particles including molybdenum was 0.01 m²/g.

### Examples 2 to 20

α-Alumina particles including molybdenum were produced in the same manner as in Example 1 except that the aluminum compound, the molybdenum compound, the types and the blending amount of potassium compound and metal compound and the firing temperature were changed as shown in Table 1.

(Evaluation)

In the same manner as in Example 1, measurement of an average particle diameter was performed.

The obtained results are shown in Table 1.

### Comparative Example 1

A powder sample (α-alumina particles including molybdenum) was produced in the same manner as in Example 1 except that a potassium compound and a metal compound were not used.

(Evaluation)

When observation of the particle shape and measurement of the average particle diameter were performed in the same manner as in Example 1, the powder sample had a polyhedron shape, and the average particle diameter was 6 μm.

In addition, in a case where measurement of the molybdenum content was performed in the same manner as in Example 1, the molybdenum content of the powder sample was 1.0% as a value in terms of molybdenum oxide.

### Comparative Example 2

A powder sample (α-alumina particles including molybdenum) was produced in the same manner as in Example 1 except that a molybdenum compound and a metal compound were not used.

(Evaluation)

In a case where observation of the particle shape and measurement of the average particle diameter were performed in the same manner as in Example 1, the powder sample had a polyhedron shape, and the average particle diameter was 7 μm.

In addition, in a case where measurement of the molybdenum content was performed in the same manner as in Example 1, molybdenum of the powder sample was not detected.

TABLE 1

| | | Molybdenum | | | | | | Average |
|---|---|---|---|---|---|---|---|---|
| | | compound | Potassium compound | | Metal compound | | Firing | particle |
| | Aluminum | Mo/Al molar | | Mo/K molar | | addition ratio | temperature | diameter |
| | Compound | ratio | Types | ratio | Types | (% by weight) | (° C.) | (μm) |
| Example 1 | Transition Al₂O₃ | 0.36 | K₂CO₃ | 0.95 | Y₂O₃ | 0.95 | 1,000 | 50 |
| Example 2 | Al(OOH) | 0.36 | K₂CO₃ | 0.52 | Y₂O₃ | 0.95 | 1,000 | 50 |
| Example 3 | Transition Al₂O₃ | 0.36 | K₂SO₄ | 0.61 | Y₂O₃ | 0.95 | 1,000 | 40 |
| Example 4 | Transition Al₂O₃ | 0.36 | K₂MoO₄ | 0.45 | Y₂O₃ | 0.95 | 1,000 | 60 |
| Example 5 | Transition Al₂O₃ | 0.36 | KCl | 0.52 | Y₂O₃ | — | 950 | 35 |
| Example 6 | Transition Al₂O₃ | 0.36 | KCl | 0.52 | Y₂O₃ | 0.19 | 950 | 40 |
| Example 7 | Transition Al₂O₃ | 0.36 | KCl | 0.52 | Y₂O₃ | 0.95 | 950 | 50 |
| Example 8 | Transition Al₂O₃ | 0.36 | KCl | 0.52 | Y₂O₃ | 3.8 | 950 | 50 |
| Example 9 | Transition Al₂O₃ | 0.36 | KCl | 0.52 | Y₂O₃ | 9.5 | 950 | 60 |
| Example 10 | Transition Al₂O₃ | 0.36 | KCl | 0.52 | Y₂O₃ | 0.95 | 925 | 70 |
| Example 11 | Transition Al₂O₃ | 0.36 | KCl | 0.52 | Y₂O₃ | 0.95 | 975 | 45 |
| Example 12 | Transition Al₂O₃ | 0.36 | KCl | 0.26 | Y₂O₃ | 0.95 | 950 | 70 |
| Example 13 | Transition Al₂O₃ | 0.36 | KCl | 1.0 | Y₂O₃ | 0.95 | 950 | 50 |
| Example 14 | Transition Al₂O₃ | 0.36 | KCl | 2.5 | Y₂O₃ | 0.95 | 950 | 25 |
| Example 15 | Transition Al₂O₃ | 0.71 | KCl | 0.52 | Y₂O₃ | 0.95 | 950 | 40 |
| Example 16 | Transition Al₂O₃ | 0.18 | KCl | 0.52 | Y₂O₃ | 0.95 | 950 | 90 |
| Example 17 | Transition Al₂O₃ | 0.09 | KCl | 0.52 | Y₂O₃ | 0.95 | 950 | 40 |
| Example 18 | Transition Al₂O₃ | 0.36 | KCl | 0.52 | MgO | 0.95 | 950 | 25 |
| Example 19 | Transition Al₂O₃ | 0.36 | KCl | 0.52 | ZrO₂ | 0.95 | 950 | 100 |
| Example 20 | Transition Al₂O₃ | 0.36 | KCl | 0.52 | CaO | 0.95 | 1,000 | 25 |
| Comparative | Transition Al₂O₃ | 0.36 | — | — | — | — | 1,000 | 6 |
| Example 1 | | | | | | | | |
| Comparative | Transition Al₂O₃ | 0 | KCl | 0 | — | — | 1,000 | 7 |
| Example 2 | | | | | | | | |

As apparent from Table 1, it was found that by using a potassium compound in combination in the flux method, it is possible to produce α-alumina particles having a large particle diameter and an average particle diameter of greater than 20 μm. Thus, by adding the α-alumina particles as a filler to the resin, it is possible to realize high thermal conductivity of the obtained resin composition (compound).

1. A method of producing α-alumina particles including molybdenum which have an average particle diameter of greater than 20 μm, comprising:
a step of firing an aluminum compound in the presence of a molybdenum compound and a potassium compound.

2. The method according to claim 1,
wherein the step of firing includes a step of forming aluminum molybdate and a step of decomposing the aluminum molybdate.

3. The method according to claim 1,
wherein the molar ratio (molybdenum/aluminum) of molybdenum atoms in the molybdenum compound to aluminum atoms in the aluminum compound is from 0.01 to 3.0.

4. The method according to claim 1,
wherein the molar ratio (molybdenum/potassium) of molybdenum atoms in the molybdenum compound to potassium atoms in the potassium compound is from 0.01 to 3.

5. The method according to claim 1,
wherein the firing temperature is 900° C. or higher.

6. The method according to claim 1,
wherein the firing is performed in the presence of a metal compound, and the metal compound includes at least one selected from the group consisting of metal compounds of the Group II, metal compounds of the Group III, and metal compounds of the Group IV.

7. The method according to claim 6,
wherein the metal compound includes at least one selected from the group consisting of magnesium compounds, calcium compounds, yttrium compounds, and zirconium compounds.

8. The method according to claim 6,
wherein the addition ratio of the metal compound is 0.02% to 20% by weight with respect to the mass conversion value of aluminum atoms in the aluminum compound.

9. A method of producing a resin composition including the α-alumina particles produced by the method according to claim 1 and a resin.

10. A method of producing a cured product, comprising:
curing the resin composition produced by the method according to claim 9.

11. The method according to claim 2,
wherein the molar ratio (molybdenum/aluminum) of molybdenum atoms in the molybdenum compound to aluminum atoms in the aluminum compound is from 0.01 to 3.0.

12. The method according to claim 2,
wherein the molar ratio (molybdenum/potassium) of molybdenum atoms in the molybdenum compound to potassium atoms in the potassium compound is from 0.01 to 3.

13. The method according to claim 3,
wherein the molar ratio (molybdenum/potassium) of molybdenum atoms in the molybdenum compound to potassium atoms in the potassium compound is from 0.01 to 3.

14. The method according to claim 2,
wherein the firing temperature is 900° C. or higher.

15. The method according to claim 3,
wherein the firing temperature is 900° C. or higher.

16. The method according to claim 4,
wherein the firing temperature is 900° C. or higher.

17. The method according to claim 2,
wherein the firing is performed in the presence of a metal compound, and the metal compound includes at least one selected from the group consisting of metal compounds of the Group II, metal compounds of the Group III, and metal compounds of the Group IV.

18. The method according to claim 3,
wherein the firing is performed in the presence of a metal compound, and the metal compound includes at least one selected from the group consisting of metal compounds of the Group II, metal compounds of the Group III, and metal compounds of the Group IV.

19. The method according to claim 7,
wherein the addition ratio of the metal compound is 0.02% to 20% by weight with respect to the mass conversion value of aluminum atoms in the aluminum compound.

20. A method of producing a resin composition including the α-alumina particles produced by the method according to claim 2 and a resin.
